(19) United States
(12) Patent Application Publication
(10) Pub. No.: US 2026/0142398 A1
(43) Pub. Date: May 21, 2026

(54) ELECTRICAL CONTACT MATERIAL

(71) Applicant: Kabushiki Kaisha Kobe Seiko Sho (Kobe Steel, Ltd.), Kobe-shi (JP)

(72) Inventors: Shintaro YAMAMOTO, Kobe-shi (JP); Sho KATSURA, Kobe-shi (JP); Hirotaka ITO, Kobe-shi (JP); Takayuki KOYAMA, Kobe-shi (JP); Masahiro TSURU, Shimonoseki-shi (JP)

(73) Assignee: Kabushiki Kaisha Kobe Seiko Sho (Kobe Steel, Ltd.), Kobe-shi (JP)

(21) Appl. No.: 18/878,733

(22) PCT Filed: Jun. 12, 2023
(86) PCT No.: PCT/JP2023/021771

§ 371 Date: Dec. 24, 2024

(30) Foreign Application Priority Data
Jul. 4, 2022 (JP) 2022-107713
Sep. 27, 2022 (JP) 2022-153957

(51) Int. Cl. H01R 13/03; C25D 3/46; C25D 7/00; C25D 15/00; H01B 1/24

(52) U.S. Cl. CPC H01R 13/03; C25D 3/46; C25D 7/00; C25D 15/00; H01B 1/24

(57) ABSTRACT

Disclosed is an electrical contact material including a silver-containing film, wherein the silver-containing film includes a silver-containing layer containing 50% by mass or more of silver and a plurality of particles made of a non-conductive organic compound, and at least part of each particle is embedded in the silver-containing layer. The non-conductive organic compound contains, in a unit molecular structure, any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)—O—). The electrical contact material satisfies the following formula (1):

$$0.5 \leq {A}_{p} / ( {A}_{p} + {A}_{A g} ) \times 100 \leq 12.10 \qquad ( 1 )$$

### TECHNICAL FIELD

The present disclosure relates to electrical contact materials.

### BACKGROUND ART

With tightening of CO₂ emission regulations, the number of electric vehicles (EVs) and plug-in hybrid vehicles (PHEVs) that are less dependent on fossil fuels is expected to increase. Since these vehicles require charging of a battery on a daily basis, an electrical contact material for connecting an external power supply to the vehicle can be inserted and removed much more frequently than an electrical contact material used in conventional vehicles. A silver (Ag) plating film with high conductivity (low electrical contact resistance) is usually applied for electrical contact materials for vehicles in many cases. The Ag plating film has generally low hardness, and “galling” tends to occur during sliding between Ag materials and, therefore, abrasion of the Ag plating film easily progresses when repeated insertion and removal (sliding) is performed.

It has long been aimed at improving the abrasion resistance of an Ag plating film, and the following methods have been studied:
(1) an increase in hardness of Ag plating by crystal grain refinement, and
(2) an increase in hardness by alloying Ag with selenium (Se) or antimony (Sb). However, neither of the methods (1) and (2) is sufficient to improve the abrasion resistance. Se and Sb are toxic elements, and need to be handled carefully, and there is also a problem that alloying with Se and Sb degrades conductivity.

Improvement in abrasion resistance other than an increase in hardness of an Ag plating film have also been studied. As disclosed in Non-Patent Documents 1 and 2, the following method has been studied:
(3) co-deposition (dispersion plating) of carbon-based particles into an Ag plating film. In this study, graphite, carbon black (CB) or carbon nanotubes (CNTs) have been mainly used. The reason for using them is considered to be that: (i) the carbon-based particles such as graphite act as a solid lubricating material, and are therefore expected to improve the abrasion resistance; and (ii) the carbon-based particles have conductivity, and therefore have a little possibility of degrading electrical contact resistance when the carbon-based particles are co-deposited (dispersed) in an Ag plating film. In fact, Non-Patent Document 1 discloses that an Ag-graphite composite plating film obtained by suspending graphite particles in an Ag plating solution for a plating process can realize good abrasion resistance compared with not only an Ag plating film, but also a hard Ag—Sb alloy plating film.

### CONVENTIONAL ART DOCUMENT

### Non-Patent Document

Non-Patent Document 1: Materia Japan, Vol. 58, No. 1 (2019), pp. 41-43
Non-Patent Document 2: Proceedings of the 81st Conference of the Surface Finishing Society of Japan, 27A-1

### DISCLOSURE OF THE INVENTION

### Problems to be Solved by the Invention

The method (3) has been studied for a long time as in Non-Patent Document 2, and can be said to be a common method for improving the abrasion resistance of a silver-containing film. However, although the demand for an electrical contact material having both abrasion resistance and conductivity has increased with prediction of an increase in EVs and PHEVs, the utilization of the method (3) has not progressed. It can be considered that the reason for this is due to a concern that when carbon particle dispersion plating is applied to an electrical contact material and sliding (insertion and removal) is repeated, the carbon-based particles held in the Ag plating film fall off with the progress of abrasion. When these carbon-based particles fall off and piled up around the contact point, short circuits at the contact point may arise. In particular, a safety problem may arise in the terminal for EVs and PHEVs that require conduction with high voltage and large current.

The present invention has been made in view of such a situation, and an object thereof is to provide a silver-containing film capable of sufficiently suppressing short circuits at a contact point due to falling off of conductive particles, and having sufficient abrasion resistance and conductivity.

### Means for Solving the Problems

Aspect 1 of the present invention provides an electrical contact material including a silver-containing film, wherein the silver-containing film includes a silver-containing layer containing 50% by mass or more of silver and a plurality of particles made of a non-conductive organic compound, and at least part of each particle is embedded in the silver-containing layer, and the non-conductive organic compound contains, in a unit molecular structure, any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)—O—), and the electrical contact material satisfies the following formula (1):

$$0.5 \leq {A}_{p} / ( {A}_{p} + {A}_{A g} ) \times 100 \leq 12.10 \qquad ( 1 )$$

where, in formula (1), Aₚ is area of the portions of the plurality of particles made of the non-conductive organic compound, that are embedded in the silver-containing layer, in a cross-section parallel to a thickness direction of the silver-containing film, and A_{Ag} is area of the silver-containing layer in the cross-section parallel to the thickness direction of the silver-containing film.

Aspect 2 of the present invention provides the electrical contact material according to Aspect 1, wherein when the non-conductive organic compound is subjected to thermogravimetric differential thermal analysis from room temperature up to 1,000° C. at a temperature rise rate of 10° C./minute, a melting point is 140° C. or higher or no melting point is exhibited.

The present invention according to a third aspect provides the electrical contact material according to Aspect 1 or 2, wherein when the non-conductive organic compound is subjected to thermogravimetric differential thermal analysis from room temperature up to 1,000° C. at a temperature rise rate of 10° C./minute, if a decomposition point is exhibited, the decomposition point is 500° C. or lower, and if a melting point is exhibited but no decomposition point is exhibited, the melting point is 500° C. or lower.

The present invention according to a fourth aspect provides the electrical contact material according to any one of Aspects 1 to 3, wherein the non-conductive organic compound contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH).

### Effects of the Invention

According to the embodiments of the present invention, it is possible to provide an electrical contact material capable of sufficiently suppressing short circuits at a contact point due to falling off of conductive particles, and having sufficient abrasion resistance and conductivity.

### BRIEF DESCRIPTION OF THE DRAWINGS

FIG. 1 is a schematic cross-sectional view of an example of an electrical contact material according to the embodiments of the present invention.

FIG. 2 is a schematic cross-sectional view of another example of an electrical contact material according to the embodiments of the present invention.

FIG. 3A is a cross-sectional SEM image of an electrical contact material No. 2 of Example 1 parallel to a film thickness direction of a silver-containing film.

FIG. 3B is an image of only the silver-containing film trimmed from FIG. 3A.

FIG. 3C is a binarized image of FIG. 3B.

FIG. 4 shows the results of heat resistance evaluation of an electrical contact material No. 10 of Example 2.

FIG. 5 shows the results of heat resistance evaluation of an electrical contact material No. 11 of Example 2.

FIG. 6 shows the results of heat resistance evaluation of an electrical contact material No. 12 of Example 2.

FIG. 7 shows the results of abrasion resistance evaluation of an electrical contact material No. 13 of Reference Example.

FIG. 8 shows the results of abrasion resistance evaluation of an electrical contact material No. 14 of Reference Example.

FIG. 9 shows the results of abrasion resistance evaluation of an electrical contact material No. 15 of Reference Example.

FIG. 10 shows the results of abrasion resistance evaluation of an electrical contact material No. 16 of Reference Example.

FIG. 11 s shows the results of abrasion resistance evaluation of an electrical contact material No. 17 of Reference Example.

FIG. 12 shows the results of abrasion resistance evaluation of an electrical contact material No. 18 of Reference Example.

FIG. 13 shows the results of abrasion resistance evaluation of an electrical contact material No. 19 of Reference Example.

FIG. 14 shows the results of abrasion resistance evaluation of an electrical contact material No. 20 of Reference Example.

FIG. 15 shows the results of abrasion resistance evaluation of an electrical contact material No. 21 of Reference Example.

FIG. 16 shows the results of abrasion resistance evaluation of an electrical contact material No. 22 of Reference Example.

FIG. 17 shows the results of abrasion resistance evaluation of an electrical contact material No. 23 of Reference Example.

FIG. 18 shows the results of abrasion resistance evaluation of an electrical contact material No. 24 of Reference Example.

FIG. 19 shows the results of abrasion resistance evaluation of an electrical contact material No. 25 of Reference Example.

FIG. 20 shows the results of abrasion resistance evaluation of an electrical contact material No. 26 of Reference Example.

FIG. 21 shows the results of abrasion resistance evaluation of an electrical contact material No. 27 of Reference Example.

FIG. 22 shows the results of abrasion resistance evaluation of an electrical contact material No. 28 of Reference Example.

### MODE FOR CARRYING OUT THE INVENTION

The inventors of the present application have studied from various angles in order to realize an electrical contact material capable of sufficiently suppressing short circuits at a contact point due to falling off of conductive particles, and having sufficient abrasion resistance and conductivity. In the study of the conventional co-deposition plating technique as disclosed in Non-Patent Document 1, carbon-based particles have been used as solid lubricating materials (and those having good conductivity). However, the inventors of the present application have further studied and found that sufficient abrasion resistance and conductivity can be obtained by including a silver-containing film in which a predetermined amount of particles made of a specific non-conductive organic compound, which does not necessarily have a solid lubricating effect, is co-precipitated (embedded) in a silver-containing layer. This reason can be considered that, during sliding of the silver-containing film, for example, part of the non-conductive organic compound decomposes and diffuses and migrates near the surface of the electrical contact material, and/or part of the non-conductive organic compound reacts with the silver-containing layer near the surface of the electrical contact material, thereby lowering the friction coefficient near the surface of the electrical contact material, leading to an improvement in abrasion resistance of the electrical contact material. The reason can be also considered that each amount of the decomposition products and reaction products is small and the proportion of particles made of a specific non-conductive organic compound in the silver-containing film is controlled to a predetermined value or less, thus making it possible to ensure sufficient conductivity.

As mentioned above, it became possible to realize an electrical contact material capable of sufficiently suppressing the risk of short circuits at a contact point due to falling off of conductive particles, and having sufficient abrasion resistance and conductivity. It should be noted that the above mechanism does not limit the scope of the embodiments of the present invention.

Hereinafter, details of requirements defined by the embodiments of the present invention will be described.

The electrical contact material according to the embodiments of the present invention includes a silver-containing film, wherein the silver-containing film includes a silver-containing layer containing 50% by mass or more of silver and a plurality of particles made of a non-conductive organic compound, and at least part of each particle is embedded in the silver-containing layer, and the non-conductive organic compound contains, in a unit molecular structure, any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)(—O—), and the electrical contact material satisfies the following formula (1):

$$0.5 \leq {A}_{p} / ( {A}_{p} + {A}_{A g} ) \times 100 \leq 12.10 \qquad ( 1 )$$

where, in formula (1), Aₚ is area of the portions of the plurality of particles made of the non-conductive organic compound, that are embedded in the silver-containing layer, in a cross-section parallel to a film thickness direction of the silver-containing film, and A_{Ag} is area of the silver-containing layer in the cross-section parallel to the thickness direction of the silver-containing film.

Thus, it is possible sufficiently suppress the risk of short circuits at a contact point due to falling off of conductive particles, and to impart sufficient abrasion resistance and conductivity.

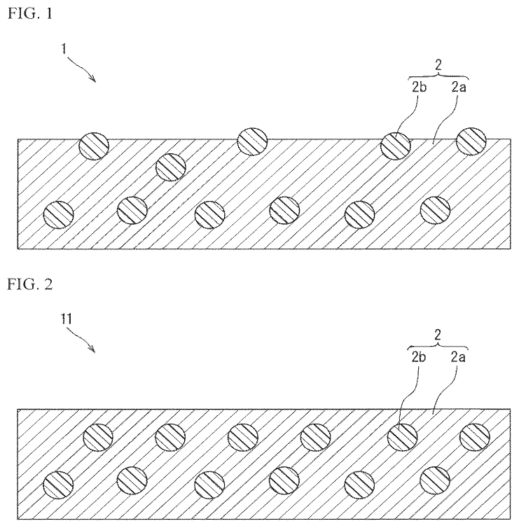

FIG. 1 shows a schematic cross-sectional view of an example of an electrical contact material according to embodiments of the present invention. In FIG. 1, an electrical contact material 1 includes a silver-containing film 2, and the silver-containing film 2 includes a silver-containing layer 2a, and a plurality of particles 2b made of a non-conductive organic compound containing, in a unit molecular structure, the above-mentioned specific functional groups (hereinafter sometimes simply referred to as “particles 2b”). FIG. 1 is a cross-section parallel to a thickness direction of the silver-containing film 2 (and the silver-containing layer 2a).

At least part of each particle 2b is embedded in the silver-containing layer 2a. In other words, each particle 2b is either completely embedded in the silver-containing layer 2a, or partially embedded in the silver-containing layer 2a with the remaining portions exposed on the surface of the silver-containing layer 2a. Further, the area Aₚ of the portions of the plurality of particles 2b embedded in the silver-containing layer 2a and the area A_{Ag} of the silver-containing layer 2a are controlled so as to satisfy the above formula (1).

The silver-containing layer 2a is a layer containing 50% by mass or more of silver. As the silver-containing layer 2a, in addition to a soft Ag plating, a hard Ag plating, a glossy Ag plating, a semi-glossy Ag plating, and the like used for a normal terminal surface treatment, an alloy plating may also be used for the purpose of improving corrosion resistance (sulfurization resistance or the like) of a matrix, improving abrasion resistance or the like. However, since the abrasion resistance can be imparted mainly by the particles 2b, when there is no other purpose such as improvement of corrosion resistance, it is preferable to use a pure Ag plating layer having excellent conductivity. For example, it is preferable that the silver-containing layer 2a contains silver in an amount of 90% by mass or more, more preferably 95% by mass or more, and still more preferably 99% by mass or more.

The average thickness of the silver-containing layer 2a (for example, the average thickness of the silver-containing layer 2a obtained from any two or more locations of the electrical contact material 1) is not particularly limited and can be appropriately adjusted according to the application, but may be, for example, 100 μm or less, or 50 μm or less.

With respect to the particles 2b, the term “non-conductive” means that the organic compound does not exhibit conductivity, and refers to, for example, particles exhibiting a volume resistivity of about 10³ [Ω·cm] or more as measured in accordance with ASTM D257.

With respect to the particles 2b, the “organic compound” refers to a compound containing carbon excluding compounds having a simple structure such as carbon monoxide, carbon dioxide, carbonate, hydrocyanic acid, cyanate, thiocyanate, B₄C, and SiC. For example, a silicone resin having a siloxane bond (—Si—O—Si—) as a main chain and having an organic group in a side chain is included in the “organic compound” herein.

The non-conductive organic compound constituting the particles 2b contains any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)—O—). By containing these specific functional groups, the abrasion resistance can be improved. More preferably, the non-conductive organic compound constituting the particles 2b contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH). Here, the “unit molecular structure” means one repeating unit in the case of a macromolecule (polymer), and an individual molecule in the case of a non-polymer.

The non-conductive organic compound constituting the particles 2b preferably has a melting point of 140° C. or higher or does not exhibit a melting point (i.e., decomposes without melting). This makes it possible to suppress deterioration of the abrasion resistance caused by melting of the organic compound when the electrical contact material 1 (and an electrical contact material 11 mentioned later) is heated to 140° C. More preferably, the melting point of the non-conductive organic compound constituting the particles 2b is 160° C. or higher. Here, the “melting point” is a melting point as determined by performing thermogravimetric differential thermal analysis (TG-DTA) under the atmosphere at a temperature rise rate of 10° C./minute from room temperature up to 1,000° C. Specifically, the melting point can be defined as a temperature within a temperature region where the mass reduction is less than 1% in the TG curve, and also as a temperature at the intersection of an extrapolated straight line to a first inflection point in the DTA curve where the heat flow rate begins to decrease with increasing temperature, and an extrapolated straight line after a second inflection point where the heat flow rate begins to decrease at a constant slope (i.e., straight line with a constant slope). When the non-conductive organic compound constituting the particles 2b does not exhibit a melting point (in the case of the compound that decomposes without melting), the decomposition point is preferably 140° C. or higher, and more preferably 160° C. or higher, 200° C. or higher, 250° C. or higher, or 300° C. or higher. Here, “decomposition point” is a decomposition point as determined, for example, by performing thermogravimetric differential thermal analysis (TG-DTA) under the atmosphere at a temperature rise rate of 10° C./minute from room temperature up to 1,000° C. Specifically, the decomposition point can be defined as a temperature within the temperature range where the mass reduction of 1% or more is confirmed in the TG curve, and also as a temperature at the intersection of an extrapolated straight line up to the first inflection point where the heat flow rate begins to decrease with increasing temperature in the DTA curve, and an extrapolated straight line after a second inflection point where the heat flow rate begins to decrease at a constant slope (i.e., straight line with a constant slope).

From the viewpoint of improving the abrasion resistance of the electrical contact material 1 (and an electrical contact material 11 mentioned later), the non-conductive organic compound constituting the particles 2b preferably has a decomposition point of 500° C. or lower. More preferably, the decomposition point is 450° C. or lower, and still more preferably 400° C. or lower. When the compound exhibits a melting point but not a decomposition point (in the case of a compound that melts but does not decompose), the melting point is preferably 500° C. or lower, more preferably 450° C.′ or lower, and still more preferably 400° C. or lower.

The combustion point of the non-conductive organic compound constituting the particles 2b is not particularly limited, but may be, for example, 180° C. or higher. Here, the “combustion point” is a combustion point as determined by performing thermogravimetric differential thermal analysis (TG-DTA) under the atmosphere at a temperature rise rate of 10° C./minute from room temperature up to 1,000° C. Specifically, the combustion point can be defined as a temperature within the temperature range where the mass reduction of 1% or more is confirmed in the TG curve, and also as a temperature at the intersection of an extrapolated straight line up to the first inflection point where the heat flow rate begins to increase with increasing temperature in the DTA curve, and an extrapolated straight line after a second inflection point where the heat flow rate begins to increase at a constant slope (i.e., straight line with a constant slope).

With respect to the particles 2b, the “particle” means a relatively small substance having an equivalent circle diameter of 50 μm or less, and the particle may have any shape. In one embodiment of the present invention, from the viewpoint of the conductivity, the average particle size (average equivalent circle diameter) of the particles 2b may be set at 10 μm or less. In one embodiment of the present invention, from the viewpoint of the abrasion resistance, the average particle size of the particles 2b may be set at 0.1 μm or more.

The upper limit of the area ratio [Aₚ/(Aₚ+A_{Ag})×100(%)] of the above formula (1) is set at 12.10%. This enables an improvement in conductivity. The upper limit is preferably set at 10.00%. Meanwhile, the lower limit of the area ratio [Aₚ/(Aₚ+AA g)×100(%)] of the above formula (1) is set at 0.50%. This enables an improvement in abrasion resistance. The lower limit is preferably set at 1.50%.

The area A_{Ag} of the silver-containing layer 2a can be determined by binarizing a cross-sectional SEM image of the silver-containing film 2 parallel to a film thickness direction using image processing software (such as “ImageJ”). Specifically, in the cross-sectional SEM image, the silver-containing layer 2a may appear relatively bright (i.e., white) and the protective layer of the cross-sectional SEM sample may appear relatively dark (i.e., black). Therefore, for example, after binarization using an intermediate brightness between the silver-containing layer 2a and the protective layer as a threshold, the area of the bright portion can be defined as the area A_{Ag} of the silver-containing layer 2a. When the upper surface of the silver-containing layer 2a has irregularities in the cross-sectional SEM image, the average line of the irregularities may be used as the boundary line between the silver-containing layer 2a and an upper layer (e.g., a protective layer of a cross-sectional SEM sample) to determine the area of the silver-containing layer 2a. The same applies to the lower surface of the silver-containing layer 2a.

Meanwhile, the area Aₚ of the portion of the multiple particles 2b that is embedded in the silver-containing layer 2a can defined as the area of the dark portion (the portion corresponding to the non-conductive organic compound) after the binarization processing that is embedded in the silver-containing layer 2a. When there are irregularities on the upper surface of the silver-containing layer 2a in the cross-sectional SEM image, the average line of the irregularities is used as the boundary line between the silver-containing layer 2a and an upper layer (e.g., a protective layer of a cross-sectional SEM sample), and the portion below the average line is defined as the portion embedded in the silver-containing layer 2a. The same applies to the lower surface of the silver-containing layer 2a.

FIG. 2 shows a schematic cross-sectional view of another example of an electrical contact material according to the embodiments of the present invention, in which each particle 2b in the electrical contact material 11 is entirely embedded in the silver-containing layer 2a. In the case of FIG. 2, the particles 2b may be of a size such that they can be completely embedded in the silver-containing layer 2a, that is, the average particle size of the particles 2b may be less than the average thickness of the silver-containing layer 2a. FIG. 2 is a cross-section parallel to a film thickness direction of the silver-containing film 2 (and the silver-containing layer 2a).

From the viewpoint of further enhancing the conductivity (further decreasing the electrical contact resistance), preferred is a mode in which each particle 2b is completely embedded in the silver-containing layer 2a as shown in FIG. 2. Meanwhile, from the viewpoint of further enhancing the abrasion resistance, preferred is a mode including particles 2b, part of which are embedded in the silver-containing layer 2a and the remaining portions of which are exposed on the surface of the silver-containing layer 2a, as shown in FIG. 1.

The electrical contact materials 1 and 11 may include particles other than the particles 2b without departing from the scope of the embodiments of the present invention. For example, the electrical contact materials 1 and 11 may include particles made of a non-conductive organic compound that does not contain the specific functional groups mentioned above, and may include inorganic particles, and may also include particles that are not embedded in the silver-containing layer 2a. Further, the electrical contact materials 1 and 11 may include conductive particles, but the fewer the amount, the more preferable it is since short circuits of the contacts due to falling off of the conductive particles can be suppressed. For example, of the particles included in the electrical contact materials 1 and 11, the non-conductive particles 2b preferably account for 50% by volume or more, and more preferably 60% by volume or more, 70% by volume or more, 80% by volume or more, or 90% by volume or more, and it is still more preferable that the non-conductive particles 2b account for 100% by volume. Further, the ratio of particles 2b, at least part of which is embedded in the silver-containing layer 2a, to all particles included in electrical contact materials 1 and 11 is preferably 50 area % or more, more preferably 60 area % or more, 70 area % or more, 80 area % or more, 90 area % or more, and still more preferably 100 area %, in a cross-section parallel to the thickness direction of the silver-containing film 2.

The electrical contact materials 1 and 11 according to the embodiments of the present invention may include another layer (for example, a substrate having conductivity, a strike plating layer, etc.) for achieving the object of the present invention. For example, in the electrical contact materials 1 and 11, the silver-containing film 2 may be formed on a substrate having conductivity (for example, a substrate made of copper or a copper alloy).

The electrical contact material 1 according to the embodiments of the present invention can be produced by, for example, dispersing a predetermined amount of particles 2b in a silver (or silver alloy) plating solution, and subjecting a substrate to a silver plating process while applying electricity with stirring, thus obtaining an electrical contact material in which a predetermined amount of particles 2b are embedded (co-deposited) in the silver-containing layer 2a. In some cases, a strike silver plating process may be performed before a silver plating process.

In the process in which the particles 2b are dispersed in a plating solution and electroplating is performed, the following reactions (A) and (B) proceed simultaneously:
(A) a reaction in which particles dispersed in a liquid are electrostatically or physically adsorbed to (contacted with) the surface of the substrate, and
(B) a reaction in which the silver-containing layer 2a is deposited (grown) on the surface of the substrate.

The particles 2b adsorbed in the reaction (A) are incorporated into the silver-containing layer 2a in the reaction (B), whereby “co-deposition” takes place. Under the conditions that the co-deposition plating proceeds steadily, the particles 2b adsorbed at the initial stage of the reaction are incorporated into the silver-containing layer 2a, and at the same time, adsorption of new particles 2b takes place. Therefore, even when the plating process is stopped, the particles 2b are exposed on the outermost surface in many cases, and in a common co-deposition plating process, it is possible to easily produce an electrical contact material 1 containing particles 2b, part of which are embedded in the silver-containing layer 2a and the remaining portions of which are exposed on the surface of the silver-containing layer 2a.

Here, the co-deposition amount of the particles 2b into the silver-containing layer 2a (for example, the area ratio of the particles 2b) is determined by the balance between the adsorption frequency in the reaction (A) and the plating film growth rate in the reaction (B). Therefore, it becomes possible to change the co-deposition amount by changing the plating conditions such as the amount of particles 2b dispersed in the plating solution. For example, it becomes possible to produce an electrical contact material 11 in which the particles 2b are completely embedded in the silver-containing layer 2a by providing a layer in which the particles 2b are not co-deposited on the outermost surface side of the plating, by performing the process using a plating solution not containing the particles 2b dispersed in the plating solution, or changing the stirring speed of the plating solution to reduce the adsorption frequency in the reaction (A).

The electrical contact materials 1 and 11 according to the embodiments of the present invention have not only sufficient conductivity but also sufficient abrasion resistance (i.e., sufficiently low friction coefficient). Specifically, the electrical contact materials 1 and 11 according to the embodiments of the present invention can achieve an initial electrical contact resistance of 0.5 mΩ or less, and a friction coefficient of 0.5 or less after 20 cycles of a sliding test mentioned below.

<Sliding Test> After forming a hard Ag plating layer (Vickers hardness HV: 160 or more) having a thickness of 40 μm or more on a substrate, a counterpart material with a hemispherical protrusion having a curvature radius R of 1.8 mm formed thereon by hand pressing is prepared, and then the counterpart material is slid against an electrical contact material 1 or 11 as a target (silver-containing film 2) under the conditions of an applied vertical load of 3 N, a sliding distance of 10 mm and a sliding speed of 80 mm/min for a predetermined number of cycles. It is possible to use, as a sliding tester, for example, a horizontal load tester manufactured by Aiko Engineering Co., Ltd.

The electrical contact materials 1 and 11 according to the embodiments of the present invention preferably have high heat resistance. Specifically, when heated at a predetermined temperature for a predetermined period of time, a friction coefficient increase ratio calculated by the following formula (2) is preferably 200% or less, and more preferably 120% or less. It is preferable to satisfy the above friction coefficient increase ratio even if the heating temperature is high, and the heating temperature is preferably 140° C. or higher, more preferably 160° C. or higher, and still more preferably 180° C. or higher. Even if the heating time is long, it is preferable to satisfy the above friction coefficient increase ratio. The heating time is preferably 100 hours or more, more preferably 200 hours or more, and still more preferably 500 hours or more.

$$Friction coefficient increase ratio ( \% ) = 100 \times [ friction coefficient after heating and performing the above - mentioned sliding test for 500 cycles ] / [ friction coefficient after performing the above - memtioned sliding test for 500 cycles without heating ] \qquad ( 2 )$$

### EXAMPLES

The embodiments of the present invention will be described in more detail by way of Examples. It is to be understood that the embodiments of the present invention are not limited to the following Examples, and various design variations made in accordance with the purports mentioned hereinbefore and hereinafter are also included in the scope of the embodiments of the present invention.

### Example 1

The surface of a pure copper plate having a thickness of 0.3 mm as a plating substrate was degreased by acetone cleaning. Then, a strike Ag plating process was performed to a thickness of about 0.1 μm as a base by using a commercially available strike Ag plating solution (Dyne Silver GPE-ST manufactured by Daiwa Fine Chemicals Co., Ltd.) and a pure Ag plate as a counter electrode, and applying electricity at a current density of 5 A/dm² for 1 minute for a plating process. The resultant was used as a substrate. Thereafter, using a commercially available non-cyanide semi-glossy Ag plating solution (Dyne Silver GPE-SB, manufactured by Daiwa Fine Chemicals Co., Ltd.), various particles and a surfactant shown in Table 1 were dispersed in the plating solution, and then electricity was applied at a current density of 3 A/dm² for 5 minutes using a pure Ag plate as a counter electrode while stirring to obtain electrical contact materials No. 1 to 9, each including a silver-containing film in which each particle is co-deposited (embedded) in an Ag plating layer having a thickness of about 10 μm (silver content: 99% by mass or more). In Nos. 1 to 9, SURFLON S231 (manufactured by AGC SEIMI CHEMICAL CO., LTD.) was used as the surfactant, and the addition amount was set at 50 g/L.

TABLE 1

| | | | | In a unit molecular | | |
|---|---|---|---|---|---|---|
| | | | | structure, are a fluoro | | |
| | | | | group, a methyl group, a | | |
| | | | Is it a non- | carbonyl group, an amino | | |
| | | | conductive | group, a hydroxy group, an | Addition | Average |
| | | | organic | ether bond and/or an ester | amount | particle |
| No. | Particle type | Manufacturer | compound? | bond included? | (g/L) | size (μm) |
| 1 | Crosslinked | GANZ PEARL | Yes | Yes (carbonyl group, ester | 1 | 2 |
| | polymethyl | GMP-0105 | | bond) | | |
| | methacrylate | manufactured by | | | | |
| | | Aica Kogyo | | | | |
| | | Company, Limited | | | | |
| 2 | Crosslinked | GANZ PEARL | Yes | Yes (carbonyl group, ester | 3 | 2 |
| | polymethyl | GMP-0105 | | bond) | | |
| | methacrylate | manufactured by | | | | |
| | | Aica Kogyo | | | | |
| | | Company, Limited | | | | |
| 3 | Crosslinked | GANZ PEARL | Yes | Yes (carbonyl group, ester | 10 | 2 |
| | polymethyl | GMP-0105, | | bond) | | |
| | methacrylate | manufactured by | | | | |
| | | Aica Kogyo | | | | |
| | | Company, Limited | | | | |
| 4 | Crosslinked | GANZ PEARL | Yes | Yes (carbonyl group, ester | 30 | 2 |
| | polymethyl | GMP-0105, | | bond) | | |
| | methacrylate | manufactured by | | | | |
| | | Aica Kogyo | | | | |
| | | Company, Limited | | | | |
| 5 | Crosslinked | GANZ PEARL | Yes | Yes (carbonyl group, ester | 70 | 2 |
| | polymethyl | GMP-0105, | | bond) | | |
| | methacrylate | manufactured by | | | | |
| | | Aica Kogyo | | | | |
| | | Company, Limited | | | | |
| 6 | Polyethylene | Polyethylene oxide | Yes | Yes (carbonyl group, | 1 | 6 |
| | oxide | powder, | | hydroxy group) | | |
| | | manufactured by | | | | |
| | | Honeywell | | | | |
| 7 | Polyethylene | Polyethylene oxide | Yes | Yes (carbonyl group, | 3 | 6 |
| | oxide | powder, | | hydroxy group) | | |
| | | manufactured by | | | | |
| | | Honeywell | | | | |
| 8 | Polyethylene | Polyethylene oxide | Yes | Yes (carbonyl group, | 10 | 6 |
| | oxide | powder, | | hydroxy group) | | |
| | | manufactured by | | | | |
| | | Honeywell | | | | |
| 9 | Polyethylene | Polyethylene oxide | Yes | Yes (carbonyl group, | 30 | 6 |
| | oxide | powder, | | hydroxy group) | | |
| | | manufactured by | | | | |
| | | Honeywell | | | | |

For the electrical contact materials Nos. 1 to 9, (a) the area ratio [Aₚ/(Aₚ+A_{Ag})×100(%)] of formula (1), (b) electrical contact resistance, and (c) abrasion resistance were evaluated.

< (a) Area Ratio [Aₚ/(Aₚ+A_{Ag})×100(%)] of Formula (1)>

Using a scanning electron microscope (SEM, S-3500N manufactured by Hitachi, Ltd.), under the conditions of an acceleration voltage of 20 kV and a working distance of 15 mm, cross-sectional SEM images (secondary electron images) parallel to a film thickness direction of the silver-containing film (and silver-containing layer) were obtained for samples of electrical contact materials Nos. 1 to 9 coated with protective layers for cross-sectional SEM. The area A_{Ag} of the silver-containing layer was determined as the area of the bright portion after the cross-sectional SEM image was binarized as mentioned above using the image processing software “ImageJ.” In the cross-sectional SEM image, the average line of the irregularities on the upper surface of the silver-containing layer was defined as the boundary line between the silver-containing layer and the protective layer of the cross-sectional SEM sample. The area Aₚ of the portion of the multiple particles that is embedded in the silver-containing layer is the area of the dark portion (corresponding to the non-conductive organic compound) that is embedded in the silver-containing layer after the binarization processing mentioned above. In the cross-sectional SEM image, the average line of the irregularities on the upper surface of the silver-containing layer was defined as the boundary line between the silver-containing layer and the protective layer of the cross-sectional SEM sample, and the portion below this average line was defined as the portion embedded in the silver-containing layer.

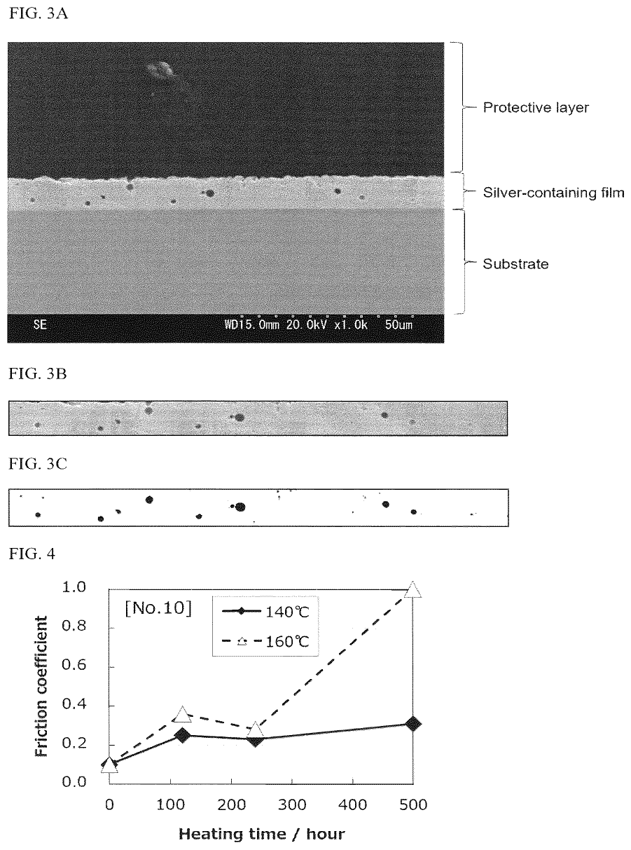

FIG. 3A to FIG. 3C show examples of calculation of the area ratio of particles. FIG. 3A is a cross-sectional SEM image parallel to a film thickness direction of the silver-containing film (and the silver-containing layer) of the electrical contact material No. 2, FIG. 3B is an image obtained by trimming only the silver-containing layer (and the particles embedded in the silver-containing layer) from FIG. 3A, and FIG. 3C is a binarized image of FIG. 3B. When the area of the black portion in FIG. 3C was divided by the area in FIG. 3B, the area ratio was 2.51%.

### <(b) Electrical Contact Resistance Evaluation>

The electrical contact resistance of the silver-containing films of the electrical contact materials Nos. 1 to 9 was measured using an electrical contact simulator (manufactured by Yamasaki-Seiki Kenkyusho, Inc.). The applied load was set at 5 N, and the average value of measurements at three points was defined as the electrical contact resistance of the electrical contact materials Nos. 1 to 9. When the electrical contact resistance was 0.50 [mΩ] or less, the electrical contact material was determined to have sufficient conductivity, which was rated as “Good”.

### <(c) Abrasion Resistance Evaluation>

After forming a hard Ag plating layer (Vickers hardness HV: 160 or more) having a thickness of 50 μm or more on a pure copper plate having a thickness of 0.25 mm, a counterpart material with a hemispherical protrusion having a curvature radius R of 1.8 mm formed thereon by hand pressing is prepared, and then the counterpart material is slid against electrical contact materials 1 to 9 under the conditions of an applied vertical load of 3 N, a sliding distance of 10 mm and a sliding speed of 80 mm/min for a predetermined number of cycles, using a sliding tester (horizontal load tester, manufactured by Aikoh Engineering Co., Ltd. The sliding cycle was 20 cycles. When the friction coefficient of 0.50 mΩ or less after sliding, the electrical contact material was determined to have sufficient abrasion resistance, which was rated as “Good”.

The above results are summarized in Table 2. In the column of “Short circuit prevention,” when 50% by volume or more of the particles included in the silver-containing layer were non-conductive particles, it was determined that short circuits at the contact point due to falling off of the particles can be sufficiently suppressed, which was rated as “Good”. Moreover, values marked with * indicate that they are outside the range of the embodiments of the present invention.

TABLE 2

| | | Evaluation results | | | | |
|---|---|---|---|---|---|---|
| | | | Conductivity | | | |
| | Area | | Electrical | | | |
| | ratio of | Short | contact | | Abrasion resistance | |
| | formula | circuit | residence | | Friction | |
| No. | (1) | suppression | [mΩ] | Judgment | coefficient | Judgment |
| 1 | *0.38 | Good | 0.20 | Good | 1.19 | Poor |
| 2 | 2.51 | Good | 0.23 | Good | 0.43 | Good |
| 3 | 7.32 | Good | 0.27 | Good | 0.45 | Good |
| 4 | 12.09 | Good | 0.50 | Good | 0.41 | Good |
| 5 | *14.55 | Good | 1.00 | Poor | 0.37 | Good |
| 6 | 0.88 | Good | 0.23 | Good | 0.17 | Good |
| 7 | 0.76 | Good | 0.27 | Good | 0.15 | Good |
| 8 | 1.11 | Good | 0.30 | Good | 0.11 | Good |
| 9 | 9.43 | Good | 0.30 | Good | 0.09 | Good |

The results of Table 2 can be considered as follows. All the electrical contact materials Nos. 2 to 4 and 6 to 9 satisfied the requirements defined in the embodiments of the present invention, and were capable of sufficiently suppressing short circuits of the contacts due to falling off of conductive particles, and had sufficient abrasion resistance and conductivity.

Meanwhile, the electrical contact materials No. 1 and No. 5 in Table 2 did not satisfy the area ratio range (0.50 to 12.10) of formula (1), which is the requirement defined in the embodiments of the present invention, and had insufficient abrasion resistance or conductivity.

### Example 2

Electrical contact materials Nos. 10 to 12 were obtained by changing the type and amount of embedded particles from Example 1 as shown in Table 3. In Nos. 10 to 12, SURFLON S231 (manufactured by AGC SEIMI CHEMICAL CO., LTD.) was used as a surfactant, and the addition amount was 50 g/L in No. 10, and 10 g/L in Nos. 11 and 12.

TABLE 3

| | | | | In a unit molecular | | |
|---|---|---|---|---|---|---|
| | | | | structure, are a fluoro | | |
| | | | | group, a methyl group, a | | |
| | | | | carbonyl group, an | | |
| | | | Is it a non- | amino group, a hydroxy | | |
| | | | conductive | group, an ether bond | Addition | Average |
| | | | organic | and/or an ester bond | amount | particle |
| No. | Particle type | Manufacturer | compound? | included? | (g/L) | size (μm) |
| 10 | Polyethylene | Polyethylene oxide | Yes | Yes (carbonyl group, | 30 | 6 |
| | oxide | powder, | | hydroxy group) | | |
| | | manufactured by | | | | |
| | | Honeywell | | | | |
| 11 | Nylon 12 | Nylon 12 powder, | Yes | Yes (carbonyl group, | 70 | 5 |
| | | manufactured by | | amino group) | | |
| | | Toray Industries, Inc. | | | | |
| 12 | Crosslinked | GANZ PEARL | Yes | Yes (carbonyl group, | 70 | 2 |
| | polymethyl | GMP-0105, | | ester bond) | | |
| | methacrylate | manufactured by | | | | |
| | | Aica Kogyo | | | | |
| | | Company, Limited | | | | |

For the electrical contact materials Nos. 10 to 12, (d) Thermogravimetric Differential Thermal Analysis (TG-DTA) and (e) Heat Resistance Evaluation were performed.

### <(d) Thermogravimetric Differential Thermal Analysis (TG-DTA)>

The organic compound particles used in the electrical contact materials No. 10 to No. 12 were subjected to thermogravimetric differential thermal analysis under the atmosphere at temperature rise rate of 10° C./minute from room temperature up to 1,000° C. using a differential thermobalance (Thermo plus EVOII, manufactured by Rigaku Corporation) to determine the melting point, decomposition point, and combustion point of each compound particle.

### <(e) Heat Resistance Evaluation>

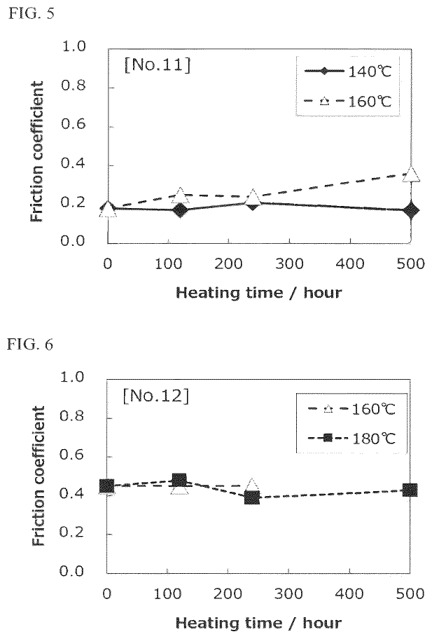

The electrical contact materials No. 10 to No. 12 were placed in an incubator (DN-43, manufactured by Yamato Scientific Co., Ltd.) set at 140 to 180° C. under atmospheric environment and heated for 100 to 500 hours, and then the sliding test in the above-mentioned (c) Abrasion Resistance Evaluation was performed. The sliding cycle was 500 cycles. FIG. 4 to FIG. 6 show the results of heat resistance evaluation of electrical contact materials Nos. 10 to 12, respectively.

The above results are summarized in Table 4. The symbols “-” in the column of “TG-DTA results” means that the corresponding temperature was not exhibited. In the column of “Heat resistance evaluation result”, when the friction coefficient increase ratio calculated by the above formula (2) when heated for 500 hours at each temperature was 120% or less, the heat resistance was rated as “Very Good (A)”, and when the friction coefficient increase ratio is 200% or less, the heat resistance was rated as “Good (B)”, and others were rated “Poor (D)”. The symbols “-” in the column of “Heat resistance evaluation result” indicates that no evaluation was performed.

TABLE 4

| | | TG/DTA results | | | | | |
|---|---|---|---|---|---|---|---|
| | | Melting | | | Heat resistance evaluation | | |
| | | point | Decomposition | Combustion | results | | |
| No. | Particle type | (° C.) | point (° C.) | point (° C.) | 140° C. | 160° C. | 180° C. |
| 10 | Polyethylene | 125 | — | 209 | D | D | — |
| | oxide | | | | | | |
| 11 | Nylon 12 | 160 | 350 | 401 | A | B | — |
| 12 | Crosslinked | — | 314 | — | — | A | A |
| | polymethyl | | | | | | |
| | methacrylate | | | | | | |

As seen from the results in Table 4, there was a correlation between the melting point of the non-conductive organic compound and the heat resistance evaluation result, and the electrical contact materials No. 11 and No. 12, which have a melting point of 140° C. or higher or no melting point, exhibited good heat resistance.

### REFERENCE EXAMPLES

Hereinafter, using Reference Examples, it will be explained that the preferable effect is exerted by the requirements of the embodiments of the present invention: “the non-conductive organic compound contains, in a unit molecular structure, any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)—O—)”.

### Reference Example 1

The surface of a pure copper plate having a thickness of 0.3 mm as a plating substrate was degreased by acetone cleaning. Then, a strike Ag plating process was performed to a thickness of about 0.1 μm as a base by using a commercially available strike Ag plating solution (Dyne Silver GPE-ST, manufactured by Daiwa Fine Chemicals Co., Ltd.) and a pure Ag plate as a counter electrode, and applying electricity at a current density of 5 A/dm² for 1 minute for a plating process. The resultant was used as a substrate. Thereafter, using a commercially available non-cyanide semi-glossy Ag plating solution (Dyne Silver GPE-SB, manufactured by Daiwa Fine Chemicals Co., Ltd.), electricity was applied at a current density of 3 A/dm² for 5 minutes using a pure Ag plate as a counter electrode to form a semi-glossy Ag plating layer (silver content: 99% by mass or more) having a thickness of about 10 μm. Thereafter, electrical contact materials No. 13 to No. 24 including a silver-containing film in contact with the surface of the Ag plating layer were fabricated by adding dropwise 0.2 ml/cm² of a solution obtained by suspending various particles (or a dispersion of particles) shown in Table 5 in an alcohol at a ratio of 20 mg/ml on the surface of the Ag plating layer, followed by drying.

TABLE 5

| | | | Average |
|---|---|---|---|
| | | | particle |
| No. | Particle type | Manufacturer | size (μm) |
| 13 | Melamine | Melamine cyanurate dispersion, | <2 |
| | cyanurate | manufactured by Nissan Chemical | |
| | | Corporation | |
| 14 | Nylon 12 | Nylon 12 powder, manufactured by | 5 |
| | | Toray Industries, Inc. | |
| 15 | Ethylene-acrylic | Flowbeads, manufactured by | 10 |
| | acid copolymer | Sumitomo Seika Chemicals | |
| | | Company, Limited | |
| 16 | Polyethylene | Polyethylene oxide powder, | 6 |
| | oxide | manufactured by Honeywell | |
| 17 | PTFE | PTFE powder, manufactured by | 3 |
| | | SEISHIN ENTERPRISE CO., | |
| | | LTD. | |
| 18 | Polypropylene | Polypropylene powder, | 5 |
| | | manufactured by SEISHIN | |
| | | ENTERPRISE CO., LTD. | |
| 19 | Paraffin | Hydrocarbon wax powder, | <0.3 |
| | | manufactured by SASOL | |
| 20 | Graphite | Powdered graphite, manufactured | 5 |
| | | by KOJUNDO CHEMICAL | |
| | | LABORATORY CO., LTD. | |
| 21 | SiC | SiC powder, manufactured by | <3 |
| | | KOJUNDO CHEMICAL | |
| | | LABORATORY CO., LTD. | |
| 22 | Talc | Talc powder, manufactured by | — |
| | | Wako Pure Chemical Industries, | |
| | | Ltd. | |
| 23 | B₄C | Boron carbide powder, | 0.5 |
| | | manufactured by KOJUNDO | |
| | | CHEMICAL LABORATORY | |
| | | CO., LTD. | |
| 24 | (Particle free) | — | — |

For the electrical contact materials No. 13 to No. 24, (f1) Abrasion Resistance Evaluation was performed.

<(f1) Abrasion Resistance Evaluation>

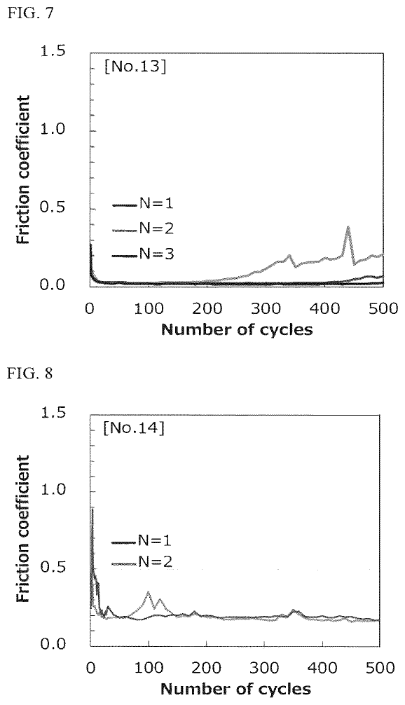

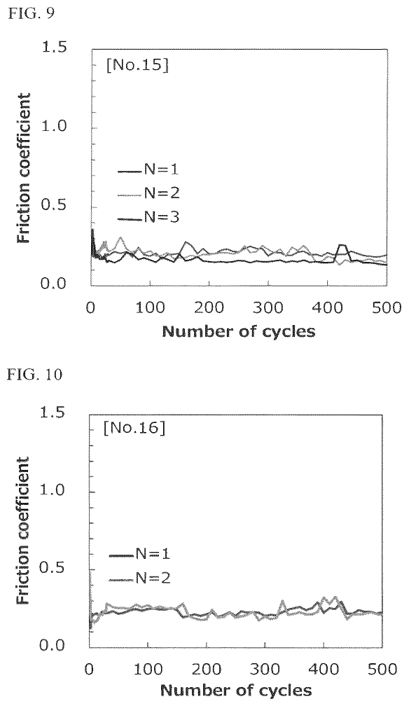

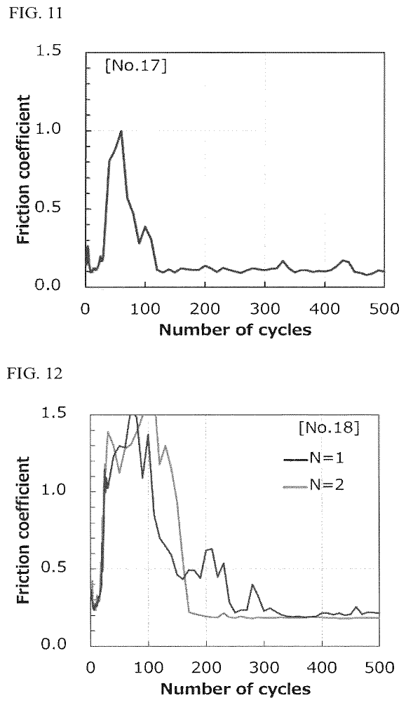

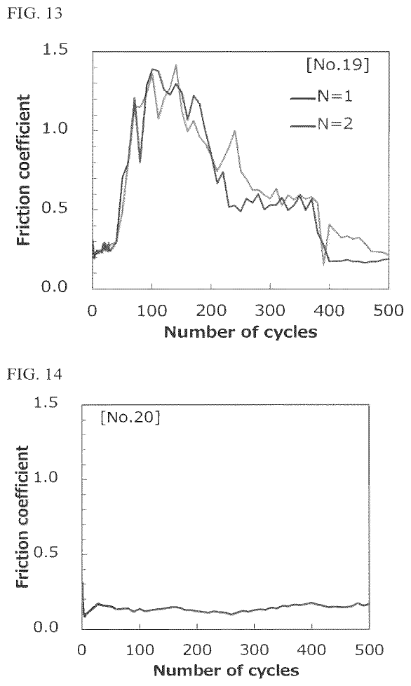

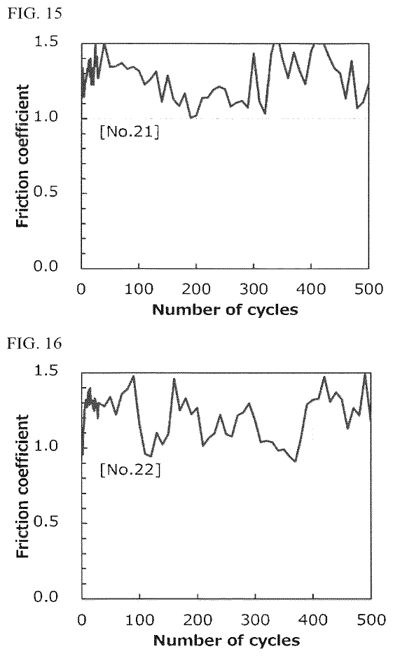

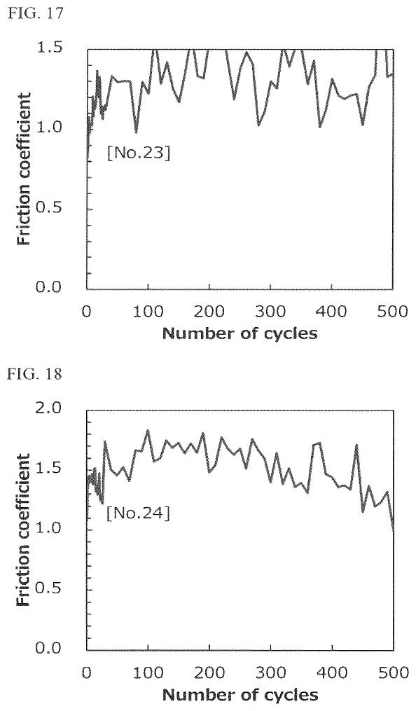

The sliding test in (c) Abrasion Resistance Evaluation of Example 1 mentioned above was performed. The maximum number of sliding cycles was 500. The results are shown in FIG. 7 to FIG. 18. FIG. 7 to FIG. 18 show the results of the sliding test performed with respect to the electrical contact materials of Test Nos. 13 to 24, respectively.

The maximum value of the friction coefficient (ratio of horizontal load to vertical load) in each sliding cycle was measured, and those having a friction coefficient of more than 0.50 after 500 cycles were determined to have insufficient abrasion resistance, which were rated as “D”, those having a friction coefficient of 0.50 or less after 500 cycles were determined to have somewhat insufficient abrasion resistance, which was rated as “C”, those having a friction coefficient of 0.50 or less after 300 cycles were determined to have sufficient abrasion resistance, which was rated as “B”, and those having a friction coefficient of 0.30 or less after 100 cycles were determined to have good abrasion resistance, which was rated as “A”, For those measured a plurality of times, determination was made based on the average value of the measurements.

The above results are summarized in Table 6. In the column of “Short circuit prevention”, when 50% by volume or more of the particles included in the electrical contact material were non-conductive particles, it was determined that short circuits at the contact point due to falling off of the particles can be sufficiently suppressed, which was rated as “Good”. When less than 50% by volume of the particles included in the electrical contact material were non-conductive particles (that is, when more than 50% by volume of the particles included in the electrical contact material were conductive particles), it was determined that there is a possibility of short circuits at the contact point due to falling off of the particles, which was rated as “Poor”.

TABLE 6

| | Properties of particles | | | | | | | | | |
|---|---|---|---|---|---|---|---|---|---|---|
| | | | | In a unit | | | | | | |
| | | | | molecular | | | | | | |
| | | | | structure, | | | | | | |
| | | | | a fluoro | | | | | | |
| | | | | group, a | | | | | | |
| | | | | methyl | | | | | | |
| | | | | group, a | | | | | | |
| | | | | carbonyl | | | | | | |
| | | | | group, an | In a unit | | | | | |
| | | | | amino | molecular | | | | | |
| | | | | group, a | structure, | | | | | |
| | | | | hydroxy | a carbonyl | | | | | |
| | | | | group, an | group, an | | | | | |
| | | | | ether bond | amino | Properties of terminal material | | | | |
| | | | | and/or an | group and | | Friction | Friction | Friction | |
| | | | Is it an | ester bond | a hydroxy | | coefficient | coefficient | coefficient | |
| | | Is it non- | organic | are | group are | Short circuit | (after 100 | (after 300 | (after 500 | |
| No. | Particle type | conductive? | compound? | included? | included? | suppression | cycles) | cycles) | cycles) | Judgment |
| 13 | Melamine | Yes | Yes | Yes | Yes | Good | 0.02 | 0.05 | 0.10 | A |
| | cyanurate | | | | | | | | | |
| 14 | Nylon 12 | Yes | Yes | Yes | Yes | Good | 0.25 | 0.19 | 0.17 | A |
| 15 | Ethylene- | Yes | Yes | Yes | Yes | Good | 0.19 | 0.18 | 0.14 | A |
| | acrylic acid | | | | | | | | | |
| | copolymer | | | | | | | | | |
| 16 | Polyethylenc | Yes | Yes | Yes | Yes | Good | 0.25 | 0.18 | 0.21 | A |
| | oxide | | | | | | | | | |
| 17 | PTFE | Yes | Yes | Yes | No | Good | 0.39 | 0.11 | 0.10 | B |
| 18 | Polypropylene | Yes | Yes | Yes | No | Good | >1.0 | 0.21 | 0.20 | B |
| 19 | Paraffin | Yes | Yes | No | No | Good | >1.0 | 0.55 | 0.20 | C |
| 20 | Graphite | No | No | No | No | Poor | 0.14 | 0.13 | 0.17 | A |
| 21 | SiC | Yes | No | No | No | Good | >1.0 | >1.0 | >1.0 | D |
| 22 | Talc | Yes | No | No | No | Good | >1.0 | >1.0 | >1.0 | D |
| 23 | B₄C | Yes | No | No | No | Good | >1.0 | >1.0 | >1.0 | D |
| 24 | (Particle free) | — | — | — | — | Good | >1.0 | >1.0 | >1.0 | D |

The results of Table 6 can be considered as follows. In all the electrical contact materials Nos. 13 to 18 in Table 6, the non-conductive organic compound contains, in a unit molecular structure, any one or more selected from the group consisting of a fluoro group, a methyl group, a carbonyl group, an amino group, a hydroxyl group, an ether bond (—O—) and an ester bond (—C(═O)—O—), and therefore the friction coefficient after 300 cycles was 0.50 or less. All the electrical contact materials Nos. 13 to 16 in Table 6 satisfied the preferable requirements that the non-conductive organic compound contains, in a unit molecular structure, any one or more selected from the group consisting of a carbonyl group, an amino group and a hydroxyl group, and therefore the friction coefficient after 100 cycles was 0.30 or less, which was a preferable result.

### Reference Example 2

The surface of a pure copper plate having a thickness of 0.3 mm as a plating substrate was degreased by acetone cleaning. Then, a strike Ag plating process was performed to a thickness of about 0.1 μm as a base by using a commercially available strike Ag plating solution (Dyne Silver GPE-ST, manufactured by Daiwa Fine Chemicals Co., Ltd.) and a pure Ag plate as a counter electrode, and applying electricity at a current density of 5 A/dm² for 1 minute for a plating process. The resultant was used as a substrate. Thereafter, using a commercially available non-cyanide semi-glossy Ag plating solution (Dyne Silver GPE-SB, manufactured by Daiwa Fine Chemicals Co., Ltd.), electricity was applied at a current density of 3 A/dm² for 5 minutes using a pure Ag plate as a counter electrode to form a semi-glossy Ag plating layer (silver content: 99% by mass or more) having a thickness of about 10 μm. Thereafter, electrical contact materials No. 25 to No. 28 including a silver-containing film in contact with the surface of the Ag plating layer were fabricated by adding dropwise 0.2 ml/cm² of a solution obtained by suspending various particles (or a dispersion of particles) shown in Table 7 in an alcohol at a ratio of 20 mg/ml on the surface of the Ag plating layer, followed by drying.

TABLE 7

| | | | Average |
|---|---|---|---|
| | | | particle |
| No. | Particle type | Manufacturer | size (μm) |
| 25 | PTFE | PTFE powder, manufactured by | 3 |
| | | SEISHIN ENTERPRISE CO., | |
| | | LTD. | |
| 26 | Polyacetal | Commercially available product, | 33 |
| | | Polyacetal powder | |
| 27 | Polyethylene | PET powder, manufactured by | 5 |
| | terephthalate (PET) | NonoChemazone | |
| 28 | Particle free | — | — |

For the electrical contact materials No. 25 to No. 28, (f2) Abrasion Resistance Evaluation was performed.

<(f2) Abrasion Resistance Evaluation>

Using a ball-on-disk testing device (Tribometer, manufactured by CSM Co.), a reciprocating sliding test for 100 cycles was performed on the electrical contact materials Nos. 25 to 28 using a φ6 mm high carbon chromium bearing steel ball (SUJ2) as the counterpart material. The applied vertical load was 1 N, the sliding width (sliding stroke) per cycle was 10 mm, and the average sliding speed was 30 mm/sec.

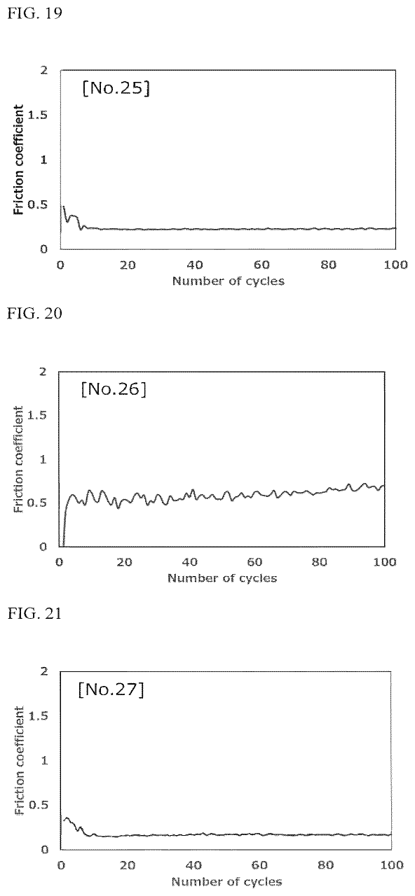

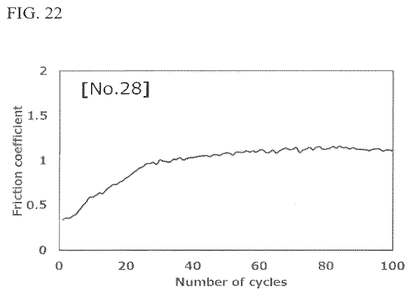

The results are shown in FIG. 19 to FIG. 22. FIG. 19 to FIG. 22 show the results of the abrasion resistance evaluation performed with respect to the electrical contact materials of Test Nos. 25 to 28, respectively.

The maximum value of the friction coefficient (ratio of horizontal load to vertical load) in each sliding cycle was measured, and those having a friction coefficient of more than 1.0 after 100 cycles were determined to have insufficient abrasion resistance, which were rated as “D”, those having a friction coefficient of 0.20 or more and 1.0 or less after 100 cycles were determined to have sufficient abrasion resistance, which was rated as “B”, and those having a friction coefficient of less than 0.20 after 100 cycles were determined to have good abrasion resistance, which was rated as “A”, For those measured a plurality of times, determination was made based on the average value of the measurements.

The above results are summarized in Table 8. In the column of “Short circuit prevention”, when 50% by volume or more of the particles included in the electrical contact material were non-conductive particles, it was determined that short circuits at the contact point due to falling off of the particles can be sufficiently suppressed, which was rated as “Good”. When less than 50% by volume of the particles included in the electrical contact material were non-conductive particles (that is, when more than 50% by volume of the particles included in the electrical contact material were conductive particles), it was determined that there is a possibility of short circuits at the contact point due to falling off of the particles, which was rated as “Poor”.

TABLE 8

| | Properties of particles | | | | | | | |
|---|---|---|---|---|---|---|---|---|
| | | | | In a unit | | | | |
| | | | | molecular | | | | |
| | | | | structure, a | | | | |
| | | | | fluoro group, a | In a unit | | | |
| | | | | methyl group, | molecular | | | |
| | | | | a carbonyl | structure, a | | | |
| | | | | group, an | carbonyl | | | |
| | | | | amino group, a | group, an | | | |
| | | | | hydroxy group, | amino group | Properties of terminal material | | |
| | | | | an ether bond | and/or a | | Friction | |
| | | | Is it an | and/or an ester | hydroxy | | coefficient | |
| | Particle | Is it non- | organic | bond are | group are | Short circuit | (after 100 | |
| No. | type | conductive? | compound? | included? | included? | suppression | cycles) | Judgment |
| 25 | PTFE | Yes | Yes | Yes | No | Good | 0.23 | B |
| 26 | Polyacetal | Yes | Yes | Yes | No | Good | 0.70 | B |
| 27 | PET | Yes | Yes | Yes | Yes | Good | 0.17 | A |
| 28 | Particle | — | — | — | — | Good | >1.0 | D |
| | free | | | | | | | |

The results of Table 8 can be considered as follows. In all the electrical contact materials Nos. 25 to 27 in Table 8, the non-conductive organic compound contains, in a unit molecular structure, any one or more selected from the group consisting of a fluoro group, a methyl group, a carbonyl group, an amino group, a hydroxyl group, an ether bond (—O—) and an ester bond (—C(═O)—O—), and therefore the friction coefficient after 100 cycles was 1.0 or less. The electrical contact material No. 27 in Table 8 satisfied the preferable requirements that the non-conductive organic compound contains, in a unit molecular structure, any one or more selected from the group consisting of a carbonyl group, an amino group and a hydroxyl group, and therefore the friction coefficient after 100 cycles was less than 0.20, which was a preferable result.

This application claims priority based on Japanese Patent Application No. 2022-107713 filed on Jul. 4, 2022 and Japanese Patent Application No. 2022-153957 filed on Sep. 27, 2022, the disclosures of which are incorporated by reference herein.

### EXPLANATION OF REFERENCES

1: Electrical contact material
2: Silver-containing film
2a: Silver-containing layer
2b: Particles made of non-conductive organic compound
11: Electrical contact material

1. An electrical contact material comprising a silver-containing film, wherein
the silver-containing film comprises a silver-containing layer containing 50% by mass or more of silver and a plurality of particles made of a non-conductive organic compound, and at least part of each particle is embedded in the silver-containing layer, and
the non-conductive organic compound contains, in a unit molecular structure, any one or more selected from the group consisting of a fluoro group (—F), a methyl group (—CH₃), a carbonyl group (—C(═O)—), an amino group (—NR¹R², wherein R¹ and R² are hydrogen or a hydrocarbon group, and R¹ and R² are the same or different), a hydroxy group (—OH), an ether bond (—O—) and an ester bond (—C(═O)—O—), and the electrical contact material satisfies the following formula (1):
$$0.5 \leq {A}_{p} / ( {A}_{p} + {A}_{A g} ) \times 100 \leq 12.10 \qquad ( 1 )$$
where, in the formula (1), Aₚ is area of the portions of the plurality of particles made of the non-conductive organic compound, that are embedded in the silver-containing layer, in a cross-section parallel to a film thickness direction of the silver-containing film, and A_{Ag} is area of the silver-containing layer in the cross-section parallel to the thickness direction of the silver-containing film.

2. The electrical contact material according to claim 1, wherein when the non-conductive organic compound is subjected to thermogravimetric differential thermal analysis from room temperature up to 1,000° C. at a temperature rise rate of 10° C./minute, a melting point is 140° C. or higher or no melting point is exhibited.

3. The electrical contact material according to claim 1, wherein when the non-conductive organic compound is subjected to thermogravimetric differential thermal analysis from room temperature up to 1,000° C. at a temperature rise rate of 10° C./minute, if a decomposition point is exhibited, the decomposition point is 500° C. or lower, and if a melting point is exhibited but no decomposition point is exhibited, the melting point is 500° C. or lower.

4. The electrical contact material according to claim 2, wherein when the non-conductive organic compound is subjected to thermogravimetric differential thermal analysis from room temperature up to 1,000° C. at a temperature rise rate of 10° C./minute, if a decomposition point is exhibited, the decomposition point is 500° C. or lower, and if a melting point is exhibited but no decomposition point is exhibited, the melting point is 500° C. or lower.

5. The electrical contact material according to claim 1, wherein the non-conductive organic compound contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH).

6. The electrical contact material according to claim 2, wherein the non-conductive organic compound contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH).

7. The electrical contact material according to claim 3, wherein the non-conductive organic compound contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH).

8. The electrical contact material according to claim 4, wherein the non-conductive organic compound contains, in a unit molecular structure, any one or more selected from the group consisting of a carbonyl group (—C(═O)—), an amino group (—NR¹R², wherein R¹ and R² are hydrogen or a hydrocarbon group, and R¹ and R² are the same or different) and a hydroxy group (—OH).
